(19) United States
(12) Patent Application Publication
(10) Pub. No.: US 2016/0304402 A1
(43) Pub. Date: Oct. 20, 2016

(54) REFRACTORY COMPOSITE COMPRISING A GEOPOLYMER AND METHOD OF MAKING A REFRACTORY COMPOSITE

(71) Applicant: The Board of Trustees of the University of Illinois, Urbana, IL (US)

(72) Inventors: Waltraud M. Kriven, Champaign, IL (US); Gregory Kutyla, Chicago, IL (US)

(21) Appl. No.: 14/832,484

(22) Filed: Aug. 21, 2015

Related U.S. Application Data
(60) Provisional application No. 62/040,710, filed on Aug. 22, 2014.

(51) Int. Cl. C04B 33/36; C04B 33/13

(52) U.S. Cl. CPC C04B 33/36; C04B 33/131; C04B 2235/5292; C04B 2235/349; C04B 2235/3427

(57) ABSTRACT

A refractory composite comprises a geopolymer and a plurality of anisotropic refractory particles dispersed in the geopolymer at a concentration of at least about 15 vol. %. The geopolymer has a composition comprising M₂O, Al₂O₃, SiO₂ and H₂O, where M includes one or more elements selected from the group consisting of: Li, Na, K, Rb and Cs. A method of making a refractory composite comprises forming a geopolymer precursor suspension, and mixing a plurality of refractory particles into the geopolymer precursor solution while exposing the geopolymer precursor solution to vibrational energy, thereby forming a precursor composite mixture. After the mixing, the vibrational energy is removed and the precursor composite mixture is cured, thereby forming a refractory composite, which may be referred to as a geopolymer composite.

### RELATED APPLICATIONS

The present patent document claims the benefit of priority under 35 U.S.C. §119(e) to U.S. Provisional Patent Application No. 62/040,710, filed on Aug. 22, 2014, which is hereby incorporated by reference in its entirety.

### FEDERALLY SPONSORED RESEARCH OR DEVELOPMENT

This invention was made with government support under contract number 919 AF FA 8650-11-1-5900 awarded by the U.S. Air Force Office of Scientific Research (AFOSR). The government has certain rights in the invention.

### TECHNICAL FIELD

The present disclosure is related generally to refractory materials and more particularly to geopolymers that include reinforcement particles.

### BACKGROUND

Geopolymers encompass inorganic aluminosilicate-based ceramics that are charge balanced by Group I oxides. Such materials may be used in industrial, structural and vehicular applications requiring heat- and fire-resistance. They can be processed simply and inexpensively from a variety of liquid aluminosilicate precursors which can set under ambient temperatures, in contrast to conventional ceramics, which are usually processed from powders. Because ceramic powders may not flow or distribute pressure evenly, complex geometries may be difficult or impossible to achieve. In addition, the presses and dies used for densifying ceramics are expensive and energy-intensive. Near-net-shape geopolymer processing does not require pressure or firing steps, and molds may be made from common plastics.

There are, however, some technical difficulties when trying to use geopolymers in refractory applications. As a geopolymer loses water, it can shrink by around 10% in length, and dehydration shrinkage may occur inhomogeneously since dehydration at common heating rates is a diffusion-limited process. Regions close to the surface of the sample tend to dehydrate faster, which may result in substantial strains or cracking across the material.

At higher temperatures, the remaining pores may consolidate, resulting in a further 10% linear shrinkage. Few applications can make use of components that will change in length that much. The length change is particularly problematic for applications that generate temperature gradients across the material, as the resulting strain gradients may result in cracks and shorten component lifespan.

Several strategies have been used to combat these problems with varying levels of success. For example, a benefit can be obtained by adding a reinforcement that does not shrink on firing to the geopolymer. The presence of the reinforcement may lower the magnitude of strain gradients throughout the material. Reinforcements can also toughen the material to reduce the damage from dehydration cracks. However, the more reinforcement is added, the harder it is to mix and shape the uncured geopolymer. For example, previous experiments with chopped fiber reinforcements have shown that the uncured geopolymer becomes unworkably viscous before enough fibers can be added for useful high-temperature performance.

### BRIEF SUMMARY

An improved refractory composite and method of making a refractory composite are described herein.

According to one embodiment, the refractory composite comprises a geopolymer and a plurality of anisotropic refractory particles dispersed in the geopolymer at a concentration of at least about 15 vol. %. The geopolymer has a composition comprising M₂O, Al₂O₃, SiO₂ and H₂O, where M includes one or more elements selected from the group consisting of: Li, Na, K, Rb and Cs.

The method of making the refractory composite comprises forming a geopolymer precursor suspension; mixing a plurality of refractory particles into the geopolymer precursor suspension while exposing the geopolymer precursor suspension to vibrational energy, thereby forming a precursor composite mixture; and after the mixing, removing the vibrational energy and curing the precursor composite mixture, thereby forming a refractory composite, which may be referred to as a geopolymer composite.

### BRIEF DESCRIPTION OF THE DRAWINGS

FIG. 1 shows a scanning electron microscope (SEM) image of an exemplary refractory composite including alumina platelets dispersed in a potassium geopolymer matrix.

FIG. 2 shows an SEM image of alumina platelets.

FIG. 3 shows a plot of 4-point flexural strengths versus firing temperature for geopolymer composites that include 30 wt. % Al₂O₃ platelets, 50 wt. % Al₂O₃ platelets, and 70 wt. % Al₂O₃ platelets.

FIG. 4 shows a plot of flexural stress versus flexural strain for a geopolymer composite sample tested at 900° C., where the dashed line indicates a change in the test program from a strain rate of 2.4×10⁻⁵ s⁻¹ to 4.6×10⁻⁵ s⁻¹.

FIG. 5 shows a plot of linear shrinkage versus firing temperature of a number of geopolymer composite samples after firing to the specified temperature. (Some data from the 300° C. firing temperature were not recorded.)

FIG. 6 shows dilatometric results (linear % change versus temperature) from room temperature to 900° C. on a previously unfired geopolymer composite sample.

FIGS. 7A-7D show SEM images of polished cross-sections of unfired, 300° C.-fired, 900° C.-fired, and 1200° C.-fired geopolymer composite samples, respectively.

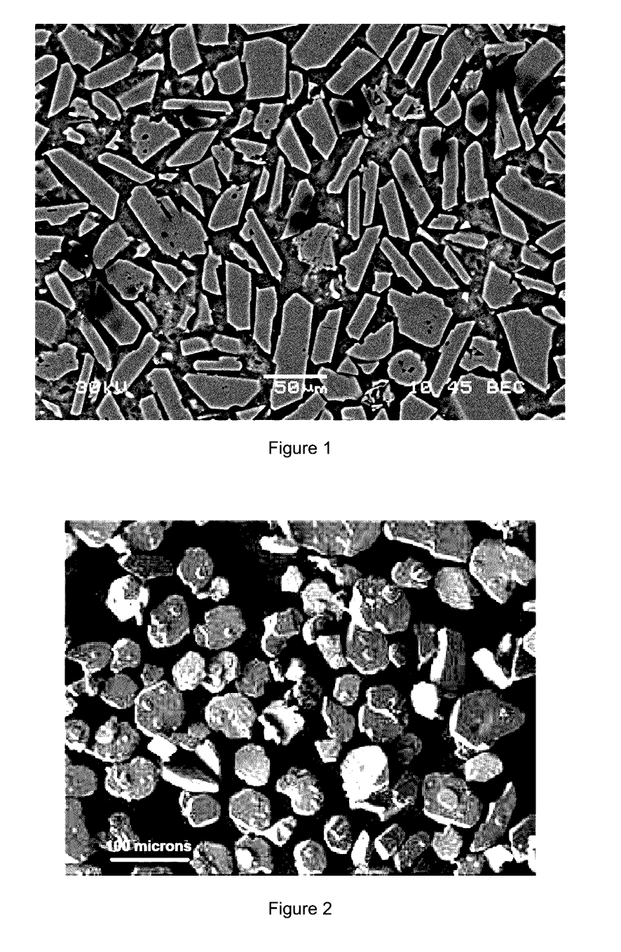

### DETAILED DESCRIPTION

Excessively high concentrations of a reinforcement phase are known to drastically reduce the flowability of geopolymer precursor suspensions, making the fabrication (e.g., mixing, casting, etc.) of geopolymer composites difficult or impossible. A new processing method has been developed that circumvents this problem and permits previously unattainable amounts of a reinforcement phase to be incorporated into a geopolymer precursor suspension without detrimentally affecting the processibility of the mixture. In some cases, the reinforcement phase is incorporated in the form of anisotropic refractory particles at a concentration of up to 50 vol. %, or higher. At sufficiently high concentrations, refractory particles having an anisotropic shape (e.g., platelets) are believed to constrain sintering and prevent the geopolymer from fully densifying, which may minimize undesirable shrinkage of the resulting composite. Accordingly, refractory composites fabricated as described herein may include high reinforcement phase loading levels and exhibit excellent thermal shock resistance.

According to one embodiment, the refractory composite comprises a geopolymer having a composition comprising M₂O, Al₂O₃, SiO₂ and H₂O, where M includes one or more elements selected from the group consisting of: Li, Na, K, Rb and Cs; and a plurality of refractory particles dispersed in the geopolymer at a concentration of at least about 15 vol. %.

The geopolymer may be referred to as the matrix phase and the plurality of refractory particles or platelets may be referred to as the reinforcement phase of the geopolymer composite (or refractory composite). In some cases, the geopolymer composite may include more than one reinforcement phase. Some compositions of the geopolymer may be referred to as alkali-activated cements.

A first molar ratio (R₁) may be defined for the geopolymer as follows: R₁=(moles of Si+moles of AD/moles of M, where 1≦R₁≦8. In some embodiments, 1≦R₁≦5. For example, R₁ may be equal to 3. A second molar ratio (R₂) may also be defined: R₂=(moles of Si)/(moles of Al), where 1≦R₂≦50. In some embodiments, 1≦R₂≦30, or 1≦R₂≦5. For example, R₂ may be equal to 2. Finally, a third molar ratio (R₃) may be defined for the geopolymer: (moles of H₂O)/(moles of Si+moles of Al), where 0.2≦R₃≦4. In some embodiments, 1≦R₃≦3. For example, R₃ may be equal to about 2, or 1.8. Thus, the geopolymer may in some cases have the following molar relationship: M₂O:Al₂O₃:4SiO₂:11H₂O.

In one example, M is K, the composition comprises K₂O, Al₂O₃, SiO₂, and H₂O, and the geopolymer may be described as a potassium geopolymer. An exemplary potassium geopolymer, which is discussed in the examples below, has the following molar relationship: K₂O:Al₂O₃:4SiO₂:11H₂O.

The reinforcement phase takes the form of refractory particles which may have a melting or decomposition temperature of at least about 700° C. In some cases, the melting or decomposition temperature of the refractory particles may be at least about 800° C., at least about 900° C., or at least about 1000° C. For example, the refractory particles may comprise an oxide, an oxynitride, a nitride, a carbide, a refractory metal, or another ceramic or mineral. More specifically, the refractory particles may comprise a material selected from among alumina, titania, zirconia, silicon carbide, mullite, calcium carbonate, dolomite, granite, mica, silica, silicon oxynitrides, tungsten, molybdenum, tantalum, niobium, and rhenium. It is understood that unreacted geopolymer precursors that may in some cases be present in the matrix phase do not constitute the refractory particles of the reinforcement phase.

The refractory particles may have any of a number of morphologies, such as spherical, acicular, or irregular, but advantageously are anisotropic in shape. The refractory particles may be uniformly or nonuniformly dispersed in the geopolymer. Because the refractory particles are used as reinforcements in the geopolymer composite, the terms “refractory particle” and “reinforcement particle” may be used alternatively in this disclosure.

The anisotropic refractory particles may have an aspect ratio greater than 1, where “aspect ratio” refers to a length-to-width aspect ratio. For example, the aspect ratio may be least about 2:1, at least about 3:1, at least about 5:1, or at least about 10:1. Typically, the aspect ratio is 100:1 or less, and may also be 50:1 or less, 20:1 or less, or 10:1 or less. The aspect ratio may depend on the type of particle. In various examples, the aspect ratio may be from about 10:1 to about 100:1, from about 10:1 to about 50:1, or from about 3:1 to about 7:1. The reinforcement particles may have a linear size (e.g., width or length) of from about 5 microns to 1000 microns, from about 10 microns to about 500 microns, or from about 30 microns to about 100 microns.

Advantageously, the refractory particles take the form of platelets, where a platelet is understood to have a thickness much smaller than its length or width. For example, the thickness of the platelet may be at least five times smaller than the length and/or width. In some cases, the thickness of the platelet may be at least 10 times smaller than the length and/or width of the platelet. The thickness of the platelet may also be up as much as 100 times smaller or as much as 1000 times smaller than the length and/or the width. Typically, the thickness of the platelets is in the range of from about 1 micron to about 100 microns. The platelet may also be anisotropic, having a length-to-width aspect ratio as set forth above.

It should be noted that when a set of particles—or more generally speaking, more than one particle—is described as having a particular aspect ratio, size or other characteristic, that aspect ratio, size or characteristic can be understood to be a nominal value for the plurality of particles, from which individual particles may have some deviation, as would be recognized by one of ordinary skill in the art.

Platelets may be advantageous over refractory particles of other shapes due a unique morphology that can minimize or prevent shrinkage during firing of the geopolymer composite while allowing for a workable viscosity during vibratory mixing of the geopolymer precursor suspension, as discussed in detail below.

Shrinkage may be prevented by two effects: Firstly, incorporation of non-shrinking materials lowers the shrinkage of the composite simply by a rule of mixtures. Secondly, the added materials may wedge up against each other and lock up the structure, preventing additional shrinkage. This second effect may still occur even for reinforcement particles that do not touch, but are affixed at points by some amount of matrix between them. The viscosity of the mixture is affected by this second mechanism as well, since reinforcements that wedge together do not flow well. Viscosity is also impacted by aspect ratio, where high aspect ratio particles may exert drag forces over larger volumes relative to their volume percent in the geopolymer composite. Reinforcement particles with an aspect ratio of about one tend to have the lowest impact on viscosity, but they may not be the most effective for preventing densification (shrinkage). Elongated particles with an aspect ratio of greater than about ten (e.g., needles/fibers) may be somewhat better at preventing shrinkage since they reinforce material all along their length; however, they may substantially increase the viscosity during mixing. Platelets are believed to be advantageous because they can wedge up against each other with multiple platelet-platelet contacts that can prevent the entire composite from shrinking (since the platelets are strong and rigid). However, with applied vibration in the uncured state, the platelets can temporarily reorient to have fewer platelet-platelet contacts, so that the precursor composite mixture described below can flow for casting.

Particles of other morphologies (e.g., isotropic particles, needles, and/or fibers) may be used in addition to platelets to improve properties and/or lower the cost of the geopolymer composite. It is believed that including at least about 15 vol. % platelets in the composite is important for minimizing shrinkage. It is also believed that higher aspect ratio platelets (e.g., platelets having an aspect ratio of at least about 10:1) are more effective as reinforcement particles than lower aspect ratio platelets. For example, alumina platelets having an aspect ratio of 5:1 may be effective as reinforcement particles at a concentration of 50 vol. %, whereas mica platelets of aspect ratio 20:1 may be effective as reinforcements at a concentration of only 15 vol. %.

As a consequence of the processing method, which is described in detail below, increased amounts of the reinforcement phase may be incorporated into the geopolymer composite. For example, the geopolymer composite may include the refractory particles (e.g., platelets) at a concentration of at least about 15 vol. %. The concentration may also be at least about 20 vol. %, at least about 30 vol. %, or at least about 40 vol. %. Typically, the concentration of refractory particles is no greater than about 50 vol. %, no greater than about 60 vol. %, or no greater than about 70 vol. %.

The method of making the refractory composite entails forming a geopolymer precursor suspension and mixing a plurality of refractory particles into the geopolymer precursor suspension, thereby forming a precursor composite mixture. The mixing may be mechanical mixing which is carried out by hand or is automated. The geopolymer precursor suspension is exposed to vibrational energy during the mixing to promote thinning of the mixture and improved flow behavior. Typically, the mixing takes place at room temperature, but may occur at any temperature from about −10° C. to 50° C. The mixing may be carried out in air or in a controlled atmosphere. It is also contemplated that the mixing may be carried out using only vibrational energy without any mechanical mixing. As a consequence of imparting vibrational energy during mixing, at least about 15 vol. % refractory particles may be mixed into the geopolymer precursor suspension without impairing processability or flowability. In some cases, the concentration of the refractory particles in the precursor composite mixture may be at least about 20 vol. %, at least about 30 vol. %, or at least about 40 vol. %, and may be as high as about 50 vol. %, about 60 vol. %, or about 70 vol. %. Generally speaking, the concentration of the refractory particles is sufficient to produce, when the geopolymer precursor suspension is not exposed to the vibrational energy, an apparent viscosity of greater than about 100 Pa·s. For example, the apparent viscosity may be greater than about 100 Pa·s, greater than about 500 Pa·S, and as high as about 1000 Pa·s, or even higher. The apparent viscosity of the geopolymer precursor suspension may be determined using methods and instruments known in the art. In some cases, parallel plate viscometry may be suitable. The refractory particles may have any of the characteristics described above or elsewhere in this disclosure.

The precursor composite mixture may then be transferred to a substrate to form a desired structure while the exposure to the vibrational energy continues. The transfer to the substrate may entail pouring, casting, dripping, extruding, spraying, pumping, and/or another transfer process. More specific examples of transfer processes may include slip casting, inkjet printing, robocasting, contour crafting and/or 3D printing. The substrate may be a planar or curved support, such as a plate, bar, rod, mold, container or other hollow or solid object. Once the vibrational energy is removed, the precursor composite mixture thickens fairly rapidly and may be cured on or in the substrate, thereby forming a structure comprising a geopolymer composite.

In one example, transfer of the precursor composite mixture to the substrate may comprise extrusion through a nozzle to form a three-dimensional structure in a layer-by-layer deposition process. Such a process may be referred to as contour crafting, 3D printing or robocasting and may benefit from the vibration induced thinning of the precursor composite mixture. To promote low-viscosity flow and prevent premature hardening of the precursor composite mixture, vibrational energy may be applied to the nozzle during extrusion.

In some cases, mixing and curing of the precursor composite mixture may occur in a single container such that the transfer of the precursor composite mixture to another substrate is not necessary to form the desired structure. For example, a geopolymer precursor suspension and plurality of refractory particles may be mixed to form a precursor composite mixture in a container while being exposed to vibrational energy, and then, after the mixing, the precursor composite mixture may undergo a forming process within the container to obtain a predetermined shape, preferably while the exposure to the vibrational energy continues. For example, an object having a desired size and shape may be used to deform the precursor composite mixture into the predetermined shape. In a simple example, a precursor composite mixture that has been mixed in a container of a first diameter may be compressed while still in the container using an object of a second diameter (which is smaller than the first diameter) to form a crucible. After forming, the vibrational energy may be removed and the precursor composite mixture may thicken and cure in the predetermined shape, thereby forming a structure comprising a geopolymer composite.

Structures formed as described in the preceding paragraphs may be suitable for various industrial applications, particularly for refractory applications. Exemplary structures include but are not limited to crucibles, molds, coatings, gating system components, rollers, oven linings, rocket nozzles, bricks, construction materials, and heat shields. As discussed further below, the structure may be resistant to thermal shock.

The geopolymer precursor suspension referred to above may comprise a mixture of an alkali metal silicate solution and metakaolin prepared in an alkaline aqueous environment. The alkali metal silicate solution may comprise M₂O, SiO₂ and H₂O, where, as described above, M may include one or more Group I elements selected from Li, Na, K, Rb and Cs. For example, the alkali metal silicate solution may be a potassium silicate solution comprising K₂O, SiO₂ and H₂O and used in a 2:1 ratio by weight with the metakaolin. The metakaolin is commercially available, such as MetaMax® from BASF (Florham Park, N.J.), or may be produced from clay calcined above 500° C. Metakaolin may be substituted by another reactive aluminosilicate material such as fly ash or slag.

The vibrational energy to which the geopolymer precursor suspension and the precursor composite mixture are exposed may be provided by any source of vibrational energy, such as a commercially available vibrating table (e.g., FMC Syntron Model J1, FMC Technologies, Houston, Tex.). Preferably, the vibrational energy has a frequency of from about 5 Hz to about 400 Hz, and in some cases the frequency may range from about 20 Hz to about 200 Hz. Using a vibrating table such as the FMC Syntron Model J1, vibration-induced thinning of the precursor composite mixture can be observed at an amplitude setting of about 10% or greater, such as from about 10% to about 100%. The amplitude setting is typically kept at about 70% amplitude. The vibrational energy may also or alternatively be provided by a resonance acoustic mixing (RAM) device, which may be obtained from Resodyn™ Acoustic Mixers, Inc. (Butte, Mont.).

The geopolymer precursor suspension and the precursor composite mixture are exposed to the vibrational energy during mixing, and any container or substrate that holds the solution/mixture may also be exposed to the vibrational energy, and/or may be used to impart the vibrational energy. As indicated above, it may be beneficial to apply the vibrational energy during further processing of the precursor composite mixture to form a desired structure, such as during forming and/or during transfer processes.

After mixing and any further processing, the vibrational energy may continue to be imparted to the precursor composite mixture for a short time sufficient for de-airing of the mixture (e.g., removal of air bubbles).

After removal of the vibrational energy, the precursor composite mixture may be cured or cross-linked, typically within a 48-hour period under ambient temperatures. In some cases, curing or cross-linking of the precursor composite mixture may occur within a 24-hour period. Some initial stiffening or curing of the precursor composite mixture may occur before the vibrational energy is removed. The curing may take place under ambient environmental conditions at room temperature, or may be expedited by heating. Some geopolymer compositions may require elevated temperatures for curing. For example, curing may be carried out at temperatures of 30° C.-80° C. In an autoclave, even higher temperatures (e.g., up to or greater than 100° C.) may be used.

The refractory composite formed as described above may comprise an amorphous geopolymer; however, the amorphous geopolymer may crystallize when exposed to a temperature above 1000° C. As described below, after firing at a temperature of from 1200° C. to 1500° C., linear shrinkage of the refractory composite may be about 3% or less, and in some cases may be 2% or less.

### Examples

Fabrication. Samples of a potassium geopolymer having the composition K₂O:Al₂O₃:4SiO₂:11H₂O can be fabricated as follows. First, a potassium silicate solution (potassium “waterglass”) is created by mixing potassium hydroxide, deionized water and fumed silica. The temperature may be maintained between 5° C. and 15° C. during synthesis, and the potassium silicate solution may be stored at 2° C. Next, to produce a liquid (uncured) potassium geopolymer, the potassium silicate solution (K₂O:2SiO₂:11H₂O) and high-quality metakaolin (BASF MetaMax®, Al₂O₃:2SiO₂) may be mixed. For example, mixing may entail using an IKA® immersion mixer equipped with a high-shear mixing blade for 5 minutes at 2500 RPM. The reinforcement particles are then mixed in (e.g., by hand), and vibrational energy is also imparted to the mixture (e.g., using a vibrating table at a frequency of 60 Hz). The platelets used in these examples are aluminum oxide (Microgrit WCA50) having a median linear size of about 50 microns and aspect ratio of 5:1, as shown in the SEM image of FIG. 2. Once the reinforcement is well-dispersed, the mixture is transferred to (poured into) a Delrin plastic mold that includes six 1 cm×1 cm×10 cm slots while continuing to impart the vibrational energy to the mixture. The mold is sealed with plastic wrap and placed into a drying oven at 50° C. to allow the mixture to cure for 24 hours to form the geopolymer composite. A total of 110 samples (18 batches) were created.

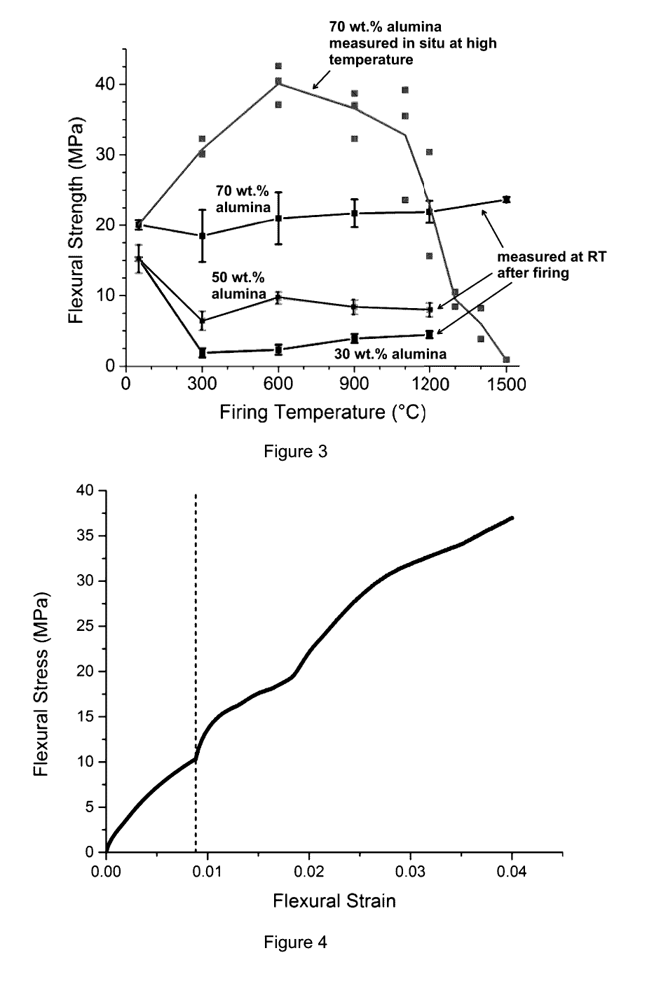

Characterization and Testing. Flexure tests were carried out to determine how the strength of the geopolymer composite changes when exposed to elevated temperatures and how the behavior varies with composition. Heat treatments were carried out in air in a Carbolite CWF 1200 Box Furnace at temperatures of 300° C., 600° C., 900° C., 1200° C. and 1500° C. The heating rate was controlled to 5° C./min and the cooling rate was controlled to 10° C./min using a Eurotherm™ Model 3216 Programmable Controller. Once at the heat treatment temperature, the samples underwent an isothermal soak for one hour. In situ samples were heated at 10° C./min in an oven attached to the testing frame. All samples were tested in four-point flexure on an Instron Universal Testing Frame according to the ASTM C78/C78M-10 guidelines. Lower supports were placed equidistant from the points at which the load was applied. The outer span was 40 mm and the inner span was 20 mm. The loading rate was set at 35.5 N/min to maintain a 1.0 MPa/min rate of stress increase. The results of flexure tests are shown in FIG. 3 for potassium geopolymer samples including 30 wt. % (15 vol. %) alumina platelets, 50 wt. % (30 vol. %) alumina platelets, and 70 wt. % (50 vol. %) alumina platelets.

It is observed that increased solids loading makes little difference to the mechanical strength of the unfired geopolymer, but makes a substantial difference after the first firing. This supports the hypothesis that much of the dehydration weakening in geopolymer systems originates from non-uniform thermal shrinkage. Since the inert reinforcement lowers the amount of shrinkage in the material, gradients in dehydration between the surface and the bulk result in less strain.

Another observation is that strength tends to increase with increasing temperature above dehydration. Given the relatively wide spread of the data and the small sample size, the statistical significance of this is uncertain. However, this may be evidence of diffusion-mediated healing of the dehydration damage.

In addition, no significant changes in strength are observed as a result of crystallization. Above 1000° C., the amorphous geopolymer crystallizes into cubic leucite. On cooling, the cubic leucite undergoes a displacive phase transition around 600° C. (in the range 450-650° C.) resulting in two lattice parameters shrinking by 1.7% and one growing by 1.2%, accompanied by a unit cell volume change of about 1.2%. A potential concern over using geopolymers for refractory applications is that the internal stresses from this transition can contribute to material failure. X-ray diffraction was used to confirm that samples fired at 1200° C. had crystallized, while samples fired at 900° C. had not. Given this, it appears that the reinforcement mitigates any detrimental effects associated with the transition.

In addition to a marked strength loss in the 30 wt. % and 50 wt. % Al₂O₃ platelet samples, as can be seen in FIG. 3, these samples were visibly degraded after heating. The 30 wt. % Al₂O₃ platelet samples showed small surface cracks after the 600° C. firing and very large cracks after 900° C. By 1200° C., some cracks spanned centimeters and had opening widths of almost 1 mm. The 50 wt. % Al₂O₃ platelet samples displayed similar behavior, but it began at 900° C.

The 30 wt. % and 50 wt. % Al₂O₃ platelet samples took on a bowed shape after firing above 600° C. The amount of bowing increased with decreasing reinforcement or increasing temperature. This was likely due to settling of the platelets toward the bottom of the mold during curing; it is believed that the low-platelet regions (top) shrank more than did the high platelet regions (bottom), resulting in curvature. Because of these serious issues with the lower concentrations, only the 70 wt. % Al₂O₃ platelet samples were investigated further.

For the 70 wt. % Al₂O₃ platelet samples, in-situ strength was found to increase to a maximum around 600° C., with values nearly double those observed on cooling (see FIG. 3). One explanation is that the thermal expansion mismatch between the matrix and reinforcement causes residual stresses on cooling, weakening the material. Another possibility is that the strength increases at elevated temperatures because the potassium geopolymer matrix becomes less brittle at these temperatures.

An interesting feature of the in-situ tests was the development of viscoelastic behavior. A viscous response was present but minimal at 600° C. By 900° C., the samples could deform to the limits of the testing fixture (flexural strains on the order of 4% as shown in FIG. 4). Samples were brittle in tests at 1100° C., but became less brittle with increasing temperature from then on. This abrupt decrease in plasticity at 1100° C. may be attributed to crystallization, which occurs above 1000° C. By 1500° C., failure strains could be as large as 2%. The recurrence of viscous flow after crystallization may be a result of an amorphous phase wetting the grain boundaries.

Perhaps the most advantageous characteristic of the 70 wt. % composite samples is their resistance to thermal shock. Samples could be blow torched from room temperature to a bright orange glow within 20 seconds, then submerged in water without cracking. This process was repeated on samples for up to five cycles, and the samples showed no damage. Tactile inspection revealed that samples lost some strength in regions with large thermal gradients; however, they were not made friable.

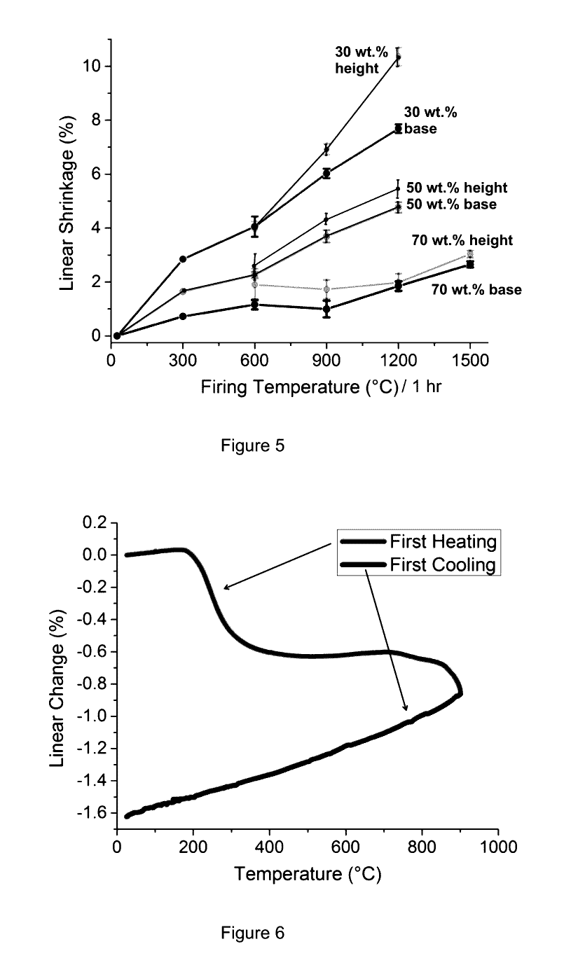

The dimensional change of the flexural testing samples before and after firing is shown in FIG. 5. With only 30 wt. % Al₂O₃ platelets, irreversible shrinkage was reduced by about a factor of two compared to a pure geopolymer. At 70 wt. % alumina platelets, shrinkage was reduced by an order of magnitude compared to a pure geopolymer, entering into the acceptable range for refractory applications. Differences in basal versus vertical shrinkage may be attributed to the settling of platelets during curing.

Dilatometry of a sample that was previously fired to 1500° C. showed no additional irreversible shrinkage. At high temperatures at which the geopolymer transforms to the cubic leucite phase, the samples exhibit a CTE of 8×10⁻⁶ K⁻¹, which is close to the CTE of alumina (8-11×10⁻⁶ K¹). Below the transition temperature, the CTE of leucite increases dramatically to around 20×10⁻⁶ K⁻¹. The observed behavior is consistent with the thermal expansion of alumina, even below the transition temperature, except for a 0.4% length change at the transition temperature. This indicates that the alumina platelet reinforcements may dominate the thermal expansion behavior.

X-ray diffraction was first used to verify that geopolymerization had taken place. An amorphous hump was observed centered at a 2θ value of about 28°, indicating that geopolymerization was not impeded even at the highest concentrations of alumina platelets. XRD was also used to identify the phases present after the firing to 900° C. and 1200° C. No new phases were observed in the sample fired at 900° C., but tetragonal leucite was observed in the sample fired at 1200° C.

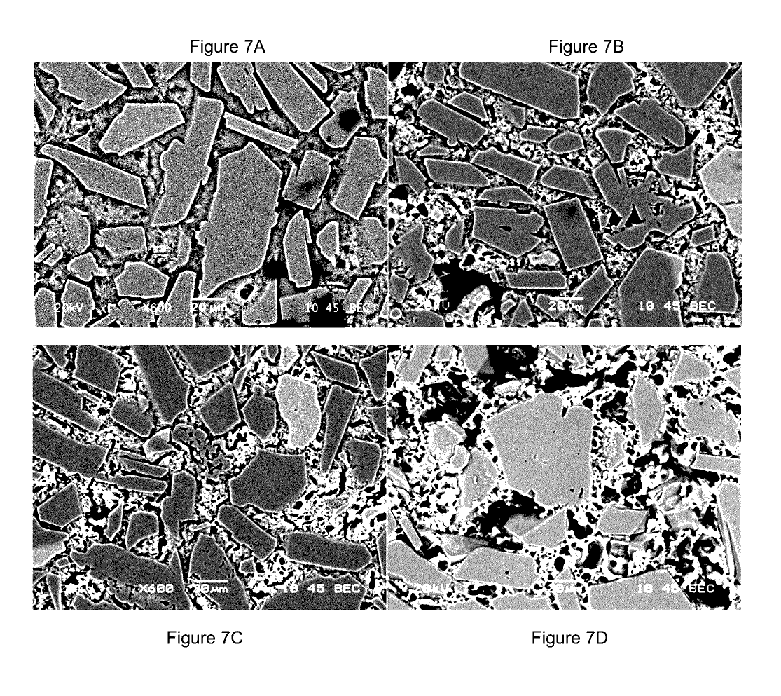

SEM images are shown in FIGS. 7A-7D. Thin microcracks can be seen in the unfired samples, possibly as a result of the water exposure during polishing. By 300° C. the cracks appeared wider, and many other voids had formed in the matrix. This trend continues as the temperature increases, seen in the 900° C. micrograph. Cracks are most prominent in wider regions without reinforcement. At 1200° C., the matrix changes in appearance into something like a ceramic sponge with a wide pore size distribution averaging around 10 μm. Microcracks are still visible, but become small hairline fractures on the pore walls. The ubiquitous presence of microcracks explains the ability of this material to accommodate the thermal strain gradients occurring during thermal shock.

Although the present invention has been described in considerable detail with reference to certain embodiments thereof, other embodiments are possible without departing from the present invention. The spirit and scope of the appended claims should not be limited, therefore, to the description of the preferred embodiments contained herein.

All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

1. A refractory composite comprising:
a geopolymer having a composition comprising M₂O, Al₂O₃, SiO₂ and H₂O, where M includes one or more elements selected from the group consisting of: Li, Na, K, Rb and Cs; and
a plurality of anisotropic refractory particles dispersed in the geopolymer at a concentration of at least about 15 vol. %.

2. The refractory composite of claim 1, wherein the anisotropic refractory particles comprise platelets.

3. The refractory composite of claim 1, wherein the anisotropic refractory particles have an aspect ratio of from about 2:1 to about 100:1.

4. The refractory composite of claim 3, wherein the aspect ratio is from about 3:1 to about 50:1.

5. The refractory composite of claim 1, wherein the anisotropic refractory particles comprise a material selected from the group consisting of: alumina, titania, zirconia, silicon carbide, mullite, calcium carbonate, dolomite, granite, mica, silica, silicon oxynitride, tungsten, molybdenum, niobium, tantalum and rhenium.

6. The refractory composite of claim 1, wherein the concentration of the anisotropic refractory particles is up to about 70 vol. %.

7. The refractory composite of claim 1, wherein the anisotropic refractory particles comprise an average linear size of from about 5 microns to 500 microns.

8. The refractory composite of claim 1, wherein the geopolymer comprises a first molar ratio R₁=(moles of Si+moles of Al)/(moles of M), where 1≦R₁≦8.

9. The refractory composite of claim 8, wherein 1≦R₁≦5.

10. The refractory composite of claim 1, wherein the geopolymer comprises a second molar ratio R₂=(moles of Si)/(moles of Al), where 1≦R₂≦50.

11. The refractory composite of claim 10, wherein 1≦R₂≦30.

12. The refractory composite of claim 1, wherein the geopolymer comprises a third molar ratio R₃=(moles of H₂O)/(moles of Si+moles of Al), where 0.2≦R₃≦4.

13. The refractory composite of claim 12, wherein 1≦R₃≦3.

14. The refractory composite of claim 1, wherein M is the element K.

15. The refractory composite of claim 14, wherein the geopolymer comprises the molar relationship: K₂O:Al₂O₃:4SiO₂:11H₂O.

16. A structure comprising the refractory composite of claim 1, wherein the structure is resistant to thermal shock.

17. The structure of claim 16 being selected from the group consisting of: crucible, mold, coating, gating system component, roller, oven lining, brick, construction material, rocket nozzle and heat shield.

18. A method of making a refractory composite, the method comprising:
forming a geopolymer precursor suspension;
mixing a plurality of refractory particles into the geopolymer precursor suspension while exposing the geopolymer precursor suspension to vibrational energy, thereby forming a precursor composite mixture; and
after the mixing, removing the vibrational energy and curing the precursor composite mixture, thereby forming a geopolymer composite.

19. The method of claim 18, further comprising, after the mixing and prior to the curing, further processing the precursor composite mixture, wherein the further processing comprises:
deforming the precursor composite mixture and/or transferring the precursor composite mixture to a substrate to form a predetermined structure,
wherein the vibrational energy is applied to the precursor composite mixture during the further processing.

20. The method of claim 19, wherein the transferring comprises at least one of: pouring, casting, dripping, extruding, spraying, and pumping the precursor composite mixture.

21. The method of claim 18, wherein the refractory particles are dispersed in the geopolymer precursor suspension at a concentration sufficient to produce, when the geopolymer precursor suspension is not exposed to the vibrational energy, an apparent viscosity thereof of greater than about 100 Pa·s.

22. The method of claim 21, wherein the apparent viscosity is greater than about 500 Pa·s.

23. The method of claim 18, wherein the refractory particles comprise anisotropic refractory particles and are dispersed in the geopolymer composite at a concentration of at least about 15 vol. %.

24. The method of claim 18, wherein the refractory particles comprise platelets.
